(19) United States
(12) Patent Application Publication
(10) Pub. No.: US 2024/0401274 A1
(43) Pub. Date: Dec. 5, 2024

(54) SHEET MANUFACTURING APPARATUS AND CLEANING DEVICE

(71) Applicant: SEIKO EPSON CORPORATION, Tokyo (JP)

(72) Inventor: Tetsuya TAMURA, Matsumoto (JP)

(21) Appl. No.: 18/676,587

(22) Filed: May 29, 2024

(30) Foreign Application Priority Data
May 31, 2023 (JP) 2023-089628

(51) Int. Cl. D21F 7/00; D21F 9/00

(52) U.S. Cl. CPC D21F 7/00; D21F 9/00

(57) ABSTRACT

A sheet manufacturing apparatus includes a first forming roller configured to heat and pressurize a web including a fiber, a first cleaning roller configured to come into contact with the first forming roller, the first cleaning roller being configured to clean the first forming roller, and a first contact mechanism configured to switch contact and separation of the first cleaning roller with and from the first forming roller.

The present application is based on, and claims priority from JP Application Serial Number 2023-089628, filed May 31, 2023, the disclosure of which is hereby incorporated by reference herein in its entirety.

### BACKGROUND

### 1. Technical Field

The present disclosure relates to a sheet manufacturing apparatus and a cleaning device.

### 2. Related Art

In related art, apparatuses for manufacturing a sheet or the like by compression-forming a web containing fibers derived from paper have been known. For example, JP-A-2022-156155 discloses a cleaning mechanism for removing paper dust adhering to a calendar roller for forming. The above-described mechanism, in a fiber structure manufacturing apparatus, causes a felt roller for cleaning to come into contact with the calendar roller to clean the calendar roller.

However, the apparatus described in JP-A-2022-156155 has a problem that it is difficult to improve durability of the felt roller. In detail, since the felt roller is always in contact with the calendar roller, the felt roller is pressed against the calendar roller and is always under load. Additionally, the felt roller comes into contact with the calendar roller while rotating. For these reasons, in the felt roller, eccentricity is likely to occur due to wear or deformation of the surface, and cleaning performance may deteriorate. The deterioration in the cleaning performance of the felt roller makes it difficult to ensure the quality of the sheet to be manufactured. In other words, a sheet manufacturing apparatus that improves the durability of the roller for cleaning has been demanded.

### SUMMARY

A sheet manufacturing apparatus includes a forming roller configured to heat and pressurize a web including a fiber, a cleaning roller configured to come into contact with the forming roller, the cleaning roller being configured to clean the forming roller, and a contact mechanism configured to switch contact and separation of the cleaning roller with and from the forming roller.

A cleaning device includes a cleaning roller configured to clean a forming member to which paper dust adheres, a contact mechanism configured to switch contact and separation of the cleaning roller with and from the forming member, and a control unit configured to control the contact mechanism.

### BRIEF DESCRIPTION OF THE DRAWINGS

FIG. 1 is a schematic view illustrating a configuration of a sheet manufacturing apparatus according to an embodiment.

FIG. 2 is a perspective view illustrating arrangement of a forming unit and a cleaning device.

FIG. 3 is a perspective view illustrating a configuration of a first cleaning device.

FIG. 4 is a perspective view illustrating a configuration of a second cleaning device.

FIG. 5 is a schematic side view illustrating a cleaning function performed by the second cleaning device.

FIG. 6 is a schematic side view illustrating the cleaning function performed by the second cleaning device.

FIG. 7 is a schematic side view illustrating the cleaning function performed by the second cleaning device.

FIG. 8 is a schematic side view illustrating the cleaning function performed by the second cleaning device.

FIG. 9 is a schematic side view illustrating a configuration of a first contact mechanism and a posture at the time of contact.

FIG. 10 is a schematic side view illustrating a posture of the first contact mechanism at the time of separation.

FIG. 11 is a schematic side view illustrating a configuration of a second contact mechanism and a posture at the time of contact.

FIG. 12 is a schematic side view illustrating a posture of the second contact mechanism at the time of separation.

FIG. 13 is a perspective view illustrating an operation mechanism of the second contact mechanism.

FIG. 14 is a perspective view illustrating the operation mechanism of the second contact mechanism.

FIG. 15 is a block diagram illustrating a configuration of a control unit.

### DESCRIPTION OF EMBODIMENTS

In the following embodiment, a sheet manufacturing apparatus 1 that recycles paper pieces of used paper or the like by a dry method will be exemplified and described with reference to the drawings. The sheet manufacturing apparatus according to the present disclosure is not limited to using the dry method, and a wet method may be used. Note that in the present specification, the term “dry method” means not to be performed in a liquid but to be performed in air such as the atmosphere.

In each of the following drawings, XYZ axes are given as coordinate axes orthogonal to each other, a direction indicated by each arrow is defined as a + direction, and a direction opposite to the + direction is defined as a − direction. The Z-axis is a virtual axis along a vertical direction, a +Z direction is defined as an upward direction, and a −Z direction is defined as a downward direction. The −Z direction is a direction in which gravity acts. In addition, in the sheet manufacturing apparatus 1, a leading side in a transport direction of a raw material, a web, a sheet, and the like may be referred to as downstream, and a side going back in the transport direction may be referred to as upstream. For convenience of illustration, a size of each member is different from an actual size.

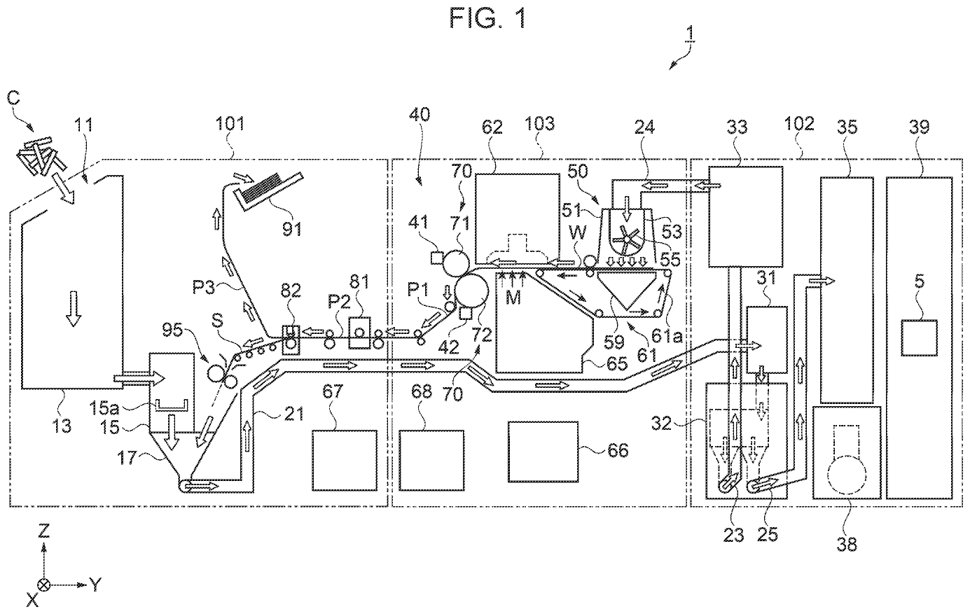

As illustrated in FIG. 1, the sheet manufacturing apparatus 1 according to the present embodiment includes a first unit group 101, a second unit group 102, and a third unit group 103. The first unit group 101, the second unit group 102, and the third unit group 103 are supported by a frame (not illustrated). Note that in FIG. 1, directions in which used paper C, sheets P3, slit pieces S, unnecessary end materials, and the like move are indicated by white arrows.

The sheet manufacturing apparatus 1 manufactures the sheets P3 from the used paper C. In the sheet manufacturing apparatus 1, the first unit group 101, the third unit group 103, and the second unit group 102 are arranged from a −Y direction toward a +Y direction in side view from a −X direction.

The used paper C is transported from the first unit group 101 to the second unit group 102 through a pipe 21 crossing the inside of the third unit group 103. The used paper C is then subjected to defibration or the like in the second unit group 102 to become fibers and is then made as a mixture containing a binder or the like. The mixture is transported to the third unit group 103 through a pipe 24. The mixture is formed into a web W in the third unit group 103 and is then formed into a sheet P1 having a belt shape. The sheet P1 having a belt shape is cut into sheets P3 in the first unit group 101.

The first unit group 101 includes a buffer tank 13, a fixed-quantity supply unit 15, a merging unit 17, and the pipe 21. In the first unit group 101, these configurations are arranged in the above-described order from upstream to downstream. Additionally, the first unit group 101 also includes a first cutting unit 81, a second cutting unit 82, a tray 91, and a shredding unit 95. The first cutting unit 81 and the second cutting unit 82 cut the sheet P1 having a belt shape into the sheets P3 having a predetermined shape. Further, the first unit group 101 includes a water supply unit 67. The water supply unit 67 is a water storage tank. The water supply unit 67 supplies water for humidification to each of a first humidifying unit 65 and a second humidifying unit 66, which will be described later, through a water supply pipe (not illustrated).

The used paper C is input from a raw material input port 11 to the buffer tank 13. The used paper C contains a fiber such as cellulose and is, for example, a paper piece of shredded used paper. Humidified air is supplied to the inside of the buffer tank 13 from the second humidifying unit 66 provided in the third unit group 103.

The used paper C to be defibrated is temporarily stored in the buffer tank 13 and is then transported to the fixed-quantity supply unit 15 according to an operation of the sheet manufacturing apparatus 1. The sheet manufacturing apparatus 1 may include a shredder that shreds the used paper C or the like, upstream from the buffer tank 13.

The fixed-quantity supply unit 15 includes a weighing device 15a and a supply mechanism (not illustrated). The weighing device 15a weighs mass of the used paper C. The supply mechanism supplies the used paper C weighed by the weighing device 15a to the merging unit 17 positioned downstream. That is, the fixed-quantity supply unit 15 weighs the used paper C for each predetermined mass by using the weighing device 15a and supplies the used paper C to the merging unit 17 positioned downstream by using the supply mechanism.

Both digital and analog weighing mechanisms can be applied to the weighing device 15a. Specific examples of the weighing device 15a include a physical sensor such as a load cell, a spring balance, and a balance. In the present embodiment, the load cell is used as the weighing device 15a. The predetermined mass by which the weighing device 15a weighs the used paper C is, for example, about from several grams to several tens of grams.

A known technique such as a vibration type feeder can be applied to the supply mechanism. The supply mechanism may be configured so as to be included in the weighing device 15a.

The weighing and supply of the used paper C in the fixed-quantity supply unit 15 is batch processing. That is, the supply of the used paper C from the fixed-quantity supply unit 15 to the merging unit 17 is intermittently performed. The fixed-quantity supply unit 15 may include a plurality of weighing devices 15a, and the plurality of weighing devices 15a may be operated at different timings to improve efficiency of the weighing.

In the merging unit 17, shredded pieces of the slit pieces S supplied from the shredding unit 95 are merged and mixed with the used paper C supplied from the fixed-quantity supply unit 15. The slit pieces S and the shredding unit 95 will be described later. The used paper C mixed with the shredded pieces flows into the pipe 21 from the merging unit 17.

The pipe 21 transports the used paper C from the first unit group 101 to the second unit group 102 by an airflow generated by a blower (not illustrated).

The second unit group 102 includes a defibrating unit 31 serving as a dry type defibrating machine, a separating unit 32, a pipe 23, a mixing unit 33, and the pipe 24. In the second unit group 102, these configurations are arranged in the above-described order from upstream to downstream. Additionally, the second unit group 102 further includes a pipe 25 coupled to the separating unit 32, a collecting unit 35, a compressor 38, and a power supply unit 39.

The used paper C transported through the pipe 21 flows into the defibrating unit 31. The defibrating unit 31 defibrates the used paper C supplied from the fixed-quantity supply unit 15 into the fibers by the dry method. A known defibrating mechanism can be applied to the defibrating unit 31.

The defibrating unit 31 includes the following configuration, for example. The defibrating unit 31 includes a stator and a rotor. The stator includes an inner surface having a substantially cylindrical shape. The rotor is installed inside the stator and rotates along the inner surface of the stator. Small pieces of the used paper C are pinched between the inner surface of the stator and the rotor, and are defibrated due to a shearing force generated therebetween. As a result, entangled fibers contained in the paper pieces of the used paper C are untangled. The used paper C is formed into the fibers and is then transported to the separating unit 32.

The separating unit 32 sorts out the defibrated fibers. In detail, the separating unit 32 removes components contained in the fibers and being unnecessary for manufacturing the sheet P3. Specifically, the separating unit 32 sorts relatively long fibers and relatively short fibers. The relatively short fibers may cause a decrease in strength of the sheet P3, and are thus sorted out by the separating unit 32. Additionally, the separating unit 32 also sorts out and removes coloring materials and additives contained in the used paper C. A known technique such as a disk mesh method can be applied to the separating unit 32.

The humidified air is supplied from the second humidifying unit 66 of the third unit group 103 to the inside of the separating unit 32.

After the relatively short fibers and the like are removed from the defibrated fibers, the defibrated fibers are transported to the mixing unit 33 through the pipe 23. The unnecessary components such as the relatively short fibers and the coloring materials are discharged to the collecting unit 35 through the pipe 25.

The mixing unit 33 mixes the fibers with a binder or the like in air to form a mixture. The mixing unit 33 includes a flow path through which the fibers are transported, a fan, a hopper, a supply pipe, and a valve, but illustration thereof is omitted.

The hopper communicates with the flow path of the fibers through the supply pipe. The valve is provided in the supply pipe between the hopper and the flow path. The hopper supplies a binder such as starch into the flow path. The valve adjusts mass of the binder to be supplied from the hopper to the flow path. Thus, a mixing ratio of the fibers and the binder is adjusted.

In addition to the above-described configuration for supplying the binder, the mixing unit 33 may include a similar configuration for supplying a coloring material, an additive, or the like.

The fan of the mixing unit 33 generates an airflow, and thus the mixing unit 33 mixes the fibers with the binder and the like in air to form a mixture while transporting the fibers downstream by the generated airflow. The mixture flows into the pipe 24 from the mixing unit 33.

The collecting unit 35 includes a filter (not illustrated). The filter filters out the unnecessary components such as the relatively short fibers transported through the pipe 25 by the airflow.

The compressor 38 generates compressed air. In the above-described filter, clogging may occur because of fine particles or the like of the unnecessary components. The compressed air generated by the compressor 38 can be blown onto the filter to blow off the adhering particles and clean the filter.

The power supply unit 39 includes a control unit 5 and a power supply device (not illustrated) that supplies power to the sheet manufacturing apparatus 1. The power supply unit 39 distributes power supplied from the outside to each configuration of the sheet manufacturing apparatus 1. The control unit 5 is electrically coupled to each configuration of the sheet manufacturing apparatus 1, and integrally controls operations of these configurations.

The third unit group 103 accumulates and compresses the mixture containing the fibers, and forms the mixture into the sheet P1 having a belt shape and being recycled paper. The third unit group 103 includes an accumulation unit 50, a first transport unit 61, a second transport unit 62, the first humidifying unit 65, the second humidifying unit 66, a drain unit 68, a forming unit 70, and a cleaning device 40.

In the third unit group 103, the accumulation unit 50, the first transport unit 61, the second transport unit 62, the first humidifying unit 65, the forming unit 70, and the cleaning device 40 are arranged in this order from upstream toward downstream. The second humidifying unit 66 is disposed below the first humidifying unit 65.

The accumulation unit 50 generates the web W by accumulating the mixture containing the sorted fibers in air. The accumulation unit 50 includes a drum member 53, a blade member 55 installed in the drum member 53, a housing 51 that accommodates the drum member 53, and a suction unit 59. The mixture is taken into the inside of the drum member 53 from the pipe 24.

The first transport unit 61 is disposed below the accumulation unit 50. The first transport unit 61 includes a mesh belt 61a and five stretch rollers (not illustrated) between which the mesh belt 61a is stretched. The suction unit 59 faces the drum member 53 with the mesh belt 61a interposed therebetween in a direction along the Z-axis.

The blade member 55 is provided inside the drum member 53 and is rotationally driven by a motor (not illustrated). The drum member 53 is a sieve having a semi-columnar shape. A net having a function of a sieve is provided at a side surface of the drum member 53 facing downward. The drum member 53 causes particles such as fibers and mixtures smaller than a mesh size of the sieve to pass therethrough from the inside to the outside.

The mixture is discharged to the outside of the drum member 53 while being stirred by the rotating blade member 55 in the drum member 53. The humidified air is supplied from the second humidifying unit 66 to the inside of the drum member 53.

The suction unit 59 is disposed below the drum member 53. The suction unit 59 sucks air in the housing 51 through a plurality of holes formed in the mesh belt 61a. The plurality of holes of the mesh belt 61a cause air to pass therethrough, but do not cause the fibers, the binder, and the like contained in the mixture to easily pass therethrough. Thus, the mixture discharged to the outside of the drum member 53 is sucked downward together with air. The suction unit 59 is a known suction device such as a blower.

The mixture is dispersed in air in the housing 51 and is then accumulated on an upper surface of the mesh belt 61a due to gravity and suction by the suction unit 59 to form the web W.

The mesh belt 61a is an endless belt and is stretched between five stretch rollers. The mesh belt 61a is rotated counterclockwise in FIG. 1 by the rotations of the stretch rollers. Thus, the mixture is continuously accumulated on the mesh belt 61a to form the web W. The web W contains a relatively large amount of air and is soft and swollen. The first transport unit 61 transports the formed web W downstream due to the rotation of the mesh belt 61a.

The second transport unit 62 transports the web W, in place of the first transport unit 61, downstream from the first transport unit 61. The second transport unit 62 peels the web W from the upper surface of the mesh belt 61a and transports the web W toward the forming unit 70. The second transport unit 62 is disposed above the transport path of the web W and slightly further upstream from a starting point on a return side of the mesh belt 61a. The +Y direction of the second transport unit 62 and the −Y direction of the mesh belt 61a partially overlap with each other in the vertical direction.

The second transport unit 62 includes a transport belt, a plurality of rollers, and a suction mechanism, which are not illustrated. A plurality of holes through which air passes are formed in the transport belt. The transport belt is stretched between the plurality of rollers and is rotated due to the rotations of the rollers.

The second transport unit 62 causes an upper surface of the web W to be sucked to a lower surface of the transport belt due to negative pressure generated by the suction mechanism. When the transport belt rotates in this state, the web W is sucked to the transport belt and transported downstream.

The first humidifying unit 65 humidifies the web W containing the fibers accumulated by the accumulation unit 50 of the third unit group 103. In detail, the first humidifying unit 65 is, for example, a mist humidifier, and humidifies the web W by supplying mist M from below to the web W being transported by the second transport unit 62. The first humidifying unit 65 is disposed below the second transport unit 62 and faces the web W being transported by the second transport unit 62 in the direction along the Z-axis. For example, a known humidifying device such as an ultrasonic humidifying device can be applied to the first humidifying unit 65.

Humidifying the web W with the mist M promotes a function of the starch as the binder and improves strength of the sheet P3. In addition, humidifying the web W from below prevents drops derived from the mist from falling onto the web W. Further, since the web W is humidified from a side opposite to a contact surface between the transport belt and the web W, sticking of the web W to the transport belt is reduced. The second transport unit 62 transports the web W to the forming unit 70.

The forming unit 70 heats and pressurizes the web W containing the fibers to form the sheet P1 having a belt shape. The forming unit 70 includes a first forming roller 71 and a second forming roller 72 as the forming roller. Each of the first forming roller 71 and the second forming roller 72 includes a built-in electric heater, and can raise a temperature of the surface of the roller.

The first forming roller 71 and the second forming roller 72 are substantially columnar members. A rotation axis of the first forming roller 71 and a rotation axis of the second forming roller 72 are arranged along the X-axis. The first forming roller 71 is disposed substantially above the transport path of the web W, and the second forming roller 72 is disposed substantially below the transport path. Between a side surface of the first forming roller 71 and a side surface of the second forming roller 72, a gap corresponding to a thickness of the sheet P3 to be manufactured is provided.

Each of the first forming roller 71 and the second forming roller 72 is rotationally driven by a forming roller drive motor, which will be described later. The web W is fed downstream while being pinched between the first forming roller 71 and the second forming roller 72 and being heated and pressurized. That is, the web W continuously passes through the forming unit 70 and is press-formed while being heated. By using a pair of the first forming roller 71 and the second forming roller 72 as the forming roller, the web W can be efficiently heated and pressurized.

When the web W passes through the forming unit 70, an amount of air contained in the web W is reduced from a soft state in which the web W contains the relatively large amount of air, and the fibers of the web W are bound to each other by the binder, which forms the web W into the sheet P1 having a belt shape. The sheet P1 having a belt shape is transported to the first unit group 101 by transport rollers (not illustrated).

The cleaning device 40 includes a first cleaning device 41 corresponding to the first forming roller 71 and a second cleaning device 42 corresponding to the second forming roller 72. The cleaning device 40 includes a cleaning roller, whose illustration is omitted.

As described above, the first forming roller 71 and the second forming roller 72 come into contact with the web W and pressurize the web W. Due to this, paper dust, fibers, and the like derived from the used paper C contained in the web W are likely to adhere to the first forming roller 71 and the second forming roller 72. When the forming is continued while the paper dust or the like adheres thereto, defects such as contamination or roughness on a surface or a decrease in sheet strength may occur in the sheet P3 to be manufactured. The cleaning roller described above comes into contact with the first forming roller 71 and the second forming roller 72, which are forming members to which the paper dust or the like adheres, and performs cleaning.

In related art, a felt roller for cleaning is brought into contact with a forming roller to clean the forming roller. However, since the felt roller is always in contact with the forming roller, a surface of the felt roller is easily worn. Further, when the forming roller has a heating function, the surface of the felt roller is always heated, so that deterioration of the felt may proceed due to the heat. Thus, in the related art, it may be difficult to secure durability of the felt roller in some cases.

In contrast, the sheet manufacturing apparatus 1 according to the present embodiment includes a contact mechanism (not illustrated). The contact mechanism switches contact and separation of the cleaning roller with and from the first forming roller 71 and the second forming roller 72. This makes it possible to appropriately separate the cleaning roller from the first forming roller 71 and the second forming roller 72. Details of the cleaning roller and the contact mechanism will be described later.

The second humidifying unit 66 is disposed below the first humidifying unit 65. A known vaporization type humidifying device can be applied to the second humidifying unit 66. Examples of the vaporization type humidifying device include a humidifying device that generates humidified air by blowing wind to a wet non-woven fabric or the like to vaporize moisture.

The second humidifying unit 66 humidifies a predetermined region of the sheet manufacturing apparatus 1. The predetermined region is one or more of the buffer tank 13, the separating unit 32, and the inside of the drum member 53 of the accumulation unit 50. Specifically, the humidified air is supplied from the second humidifying unit 66 to the above-described region through a plurality of pipes (not illustrated). The humidified air suppresses charging of the used paper C, fibers, and the like in each of the above-described configurations to suppress adhesion of the used paper C, the fibers, and the like to members due to static electricity.

The drain unit 68 is a drain tank. The drain unit 68 collects and stores old moisture that is used in the first humidifying unit 65, the second humidifying unit 66, and the like. The drain unit 68 can be removed from the sheet manufacturing apparatus 1 as necessary to discard the accumulated water.

The sheet P1 having a belt shape and being transported to the first unit group 101 reaches the first cutting unit 81. The first cutting unit 81 cuts the sheet P1 having a belt shape in a direction intersecting the transport direction, for example, in a direction along the X-axis. The sheet P1 having a belt shape is cut into a sheet P2 having a single-cut shape by the first cutting unit 81. The sheet P2 having a single-cut shape is transported from the first cutting unit 81 to the second cutting unit 82.

The second cutting unit 82 cuts the sheet P2 having a single-cut shape in the transport direction, for example, in a direction along the Y-axis. In detail, the second cutting unit 82 cuts vicinities of both sides of the sheet P2 having a single-cut shape in the direction along the X-axis. As a result, the sheet P2 having a single-cut shape becomes a sheet P3 having a predetermined shape with a size such as an A4 size or an A3 size.

When the sheet P2 having a single-cut shape is cut into the sheet P3 in the second cutting unit 82, the slit pieces S that are end materials are generated. The slit pieces S are transported substantially in the −Y direction and reach the shredding unit 95 serving as a shredder. The shredding unit 95 shreds the slit pieces S into shredded pieces and supplies the shredded pieces to the merging unit 17. A mechanism for weighing the shredded pieces of the slit pieces S and supplying the shredded pieces to the merging unit 17 may be installed between the shredding unit 95 and the merging unit 17.

The sheet P3 is transported substantially upward and stacked on the tray 91. As described above, the sheet P3 is manufactured by the sheet manufacturing apparatus 1. The sheet P3 can be used as a substitute for, for example, a copy paper.

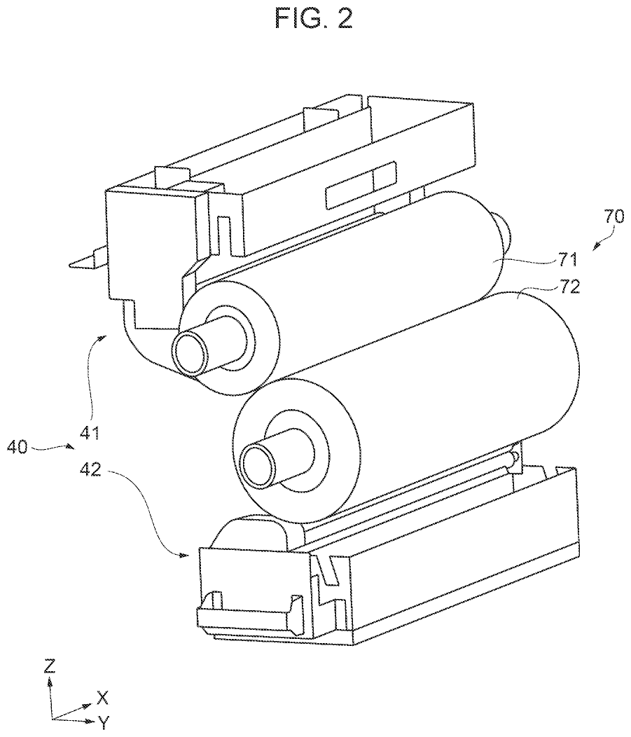

As illustrated in FIG. 2, the first cleaning device 41 is disposed slightly above the first forming roller 71 in the −Y direction and along the first forming roller 71. The second cleaning device 42 is disposed along the second forming roller 72 at a position closer to the −Y direction below the second forming roller 72.

In the direction along the X-axis, a length of the first cleaning device 41 is substantially equal to a length of the side surface of the first forming roller 71. Similarly, a length of the second cleaning device 42 is substantially equal to a length of the second forming roller 72.

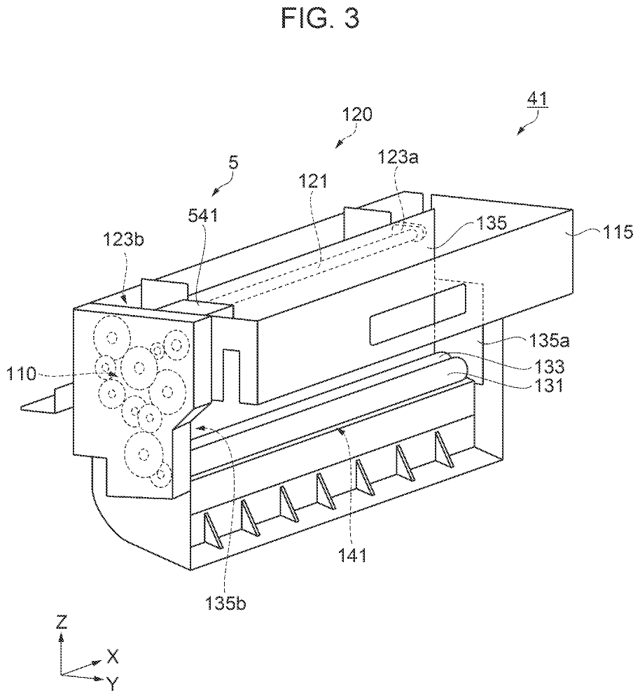

As illustrated in FIG. 3, the first cleaning device 41 includes a first contact mechanism 120, a first cleaning roller 131, a brush unit 133, a blade unit 141, a gear group 110, a support member 135, and a frame unit 115. Note that in FIG. 3, a cleaning roller drive motor 541 included in the control unit 5 is also illustrated.

The first cleaning roller 131, of the above-described cleaning roller, cleans the first forming roller 71. The first contact mechanism 120, of the above-described contact mechanism, corresponds to the first cleaning roller 131.

The first contact mechanism 120 includes a shaft unit 121 and cam members 123a and 123b. The shaft unit 121 is a rod-shaped member disposed along the X-axis. The cam member 123a is attached near an end portion of the shaft unit 121 in a +X direction, and the cam member 123b is attached near an end portion of the shaft unit 121 in the −X direction.

The shaft unit 121 is supported by the frame unit 115 and rotates about a rotation axis along the X-axis. The end portion of the shaft unit 121 in the −X direction is directly coupled to one of gears of the gear group 110. When the gear group 110 is driven, the shaft unit 121 is rotationally driven. The cam members 123a and 123b rotate about the shaft unit 121 in conjunction with the rotation of the shaft unit 121.

The first cleaning roller 131 is a substantially columnar member, and is disposed such that a height direction of the column is along the X-axis. Both ends of the first cleaning roller 131 in the direction along the X-axis are supported by the support member 135, and the first cleaning roller 131 rotates about a rotation axis along the X-axis. The first cleaning roller 131 is rotationally driven by one of the gears of the gear group 110.

The brush unit 133 comes into contact with the first cleaning roller 131 to clean the first cleaning roller 131. The brush unit 133 is a substantially columnar member, is disposed such that a height direction of the column is along the X-axis, and is disposed side by side with the first cleaning roller 131 in the direction along the Y-axis. Both ends of the brush unit 133 in the direction along the X-axis are supported by the support member 135, and the brush unit 133 rotates about a rotation axis along the X-axis. The brush unit 133 is also rotationally driven by one of the gears of the gear group 110.

The blade unit 141 comes into contact with the brush unit 133 from below to clean the brush unit 133. The blade unit 141 is a substantially rectangular plate-shaped member and extends along a side surface of the brush unit 133. The blade unit 141 is supported by the support member 135.

The gear group 110 includes a plurality of gears. The plurality of gears are rotated by the driving by the cleaning roller drive motor 541 to rotate the shaft unit 121, the first cleaning roller 131, and the brush unit 133. The gear group 110 and the cleaning roller drive motor 541 are installed at an end portion of the frame unit 115 in the −X direction.

The support member 135 includes a main body (not illustrated) along an XZ plane and support units 135a and 135b protruding in the +Y direction from both ends of the main body in the direction along the X-axis in plan view from above. The support units 135a and 135b face each other in the direction along the X-axis. The first contact mechanism 120, the first cleaning roller 131, the brush unit 133, and the blade unit 141 are arranged between the support units 135a and 135b. That is, the support units 135a and 135b support the first contact mechanism 120, the first cleaning roller 131, the brush unit 133, and the blade unit 141.

The support member 135 can relatively change a posture thereof with respect to the frame unit 115 while being supported by the frame unit 115. The posture change of the support member 135 will be described later.

The frame unit 115 is a substantially frame-shaped member in plan view from above, and the support member 135 is disposed inside thereof. At the end portion of the frame unit 115 in the −X direction, the gear group 110 is disposed in the −X direction positioned outside the end portion, and the cleaning roller drive motor 541 is disposed in the +X direction positioned inside the end portion. The cleaning roller drive motor 541 includes a shaft (not illustrated) serving as an output shaft. The shaft passes through the frame unit 115, extends in the −X direction, and is directly coupled to one of the plurality of gears of the gear group 110. The frame unit 115 is supported by a frame of the third unit group 103 of the sheet manufacturing apparatus 1.

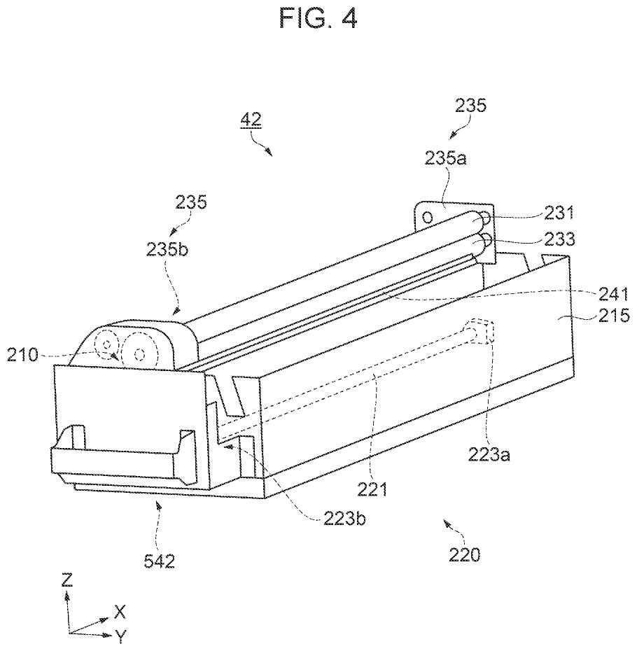

As illustrated in FIG. 4, the second cleaning device 42 includes a second contact mechanism 220, a second cleaning roller 231, a brush unit 233, a blade unit 241, a gear group 210, a support member 235, and a frame unit 215. Note that in FIG. 4, a cleaning roller drive motor 542 included in the control unit 5 is also illustrated.

The second cleaning roller 231, of the above-described cleaning roller, cleans the second forming roller 72. The second contact mechanism 220, of the above-described contact mechanism, corresponds to the second cleaning roller 231.

The second contact mechanism 220 includes a shaft unit 221 and cam members 223a and 223b. The shaft unit 221 is a rod-shaped member disposed along the X-axis. The cam member 223a is attached near an end portion of the shaft unit 221 in the +X direction, and the cam member 223b is attached near an end portion of the shaft unit 221 in the −X direction.

The shaft unit 221 is supported by the frame unit 215 and rotates about a rotation axis along the X-axis. The end portion of the shaft unit 221 in the −X direction is directly coupled to one of gears of the gear group 210. When the gear group 210 is driven, the shaft unit 221 is rotationally driven. The cam members 223a and 223b rotate about the shaft unit 221 in conjunction with the rotation of the shaft unit 221.

The second cleaning roller 231 is a substantially columnar member, and is disposed such that a height direction of the column is along the X-axis. Both ends of the second cleaning roller 231 in the direction along the X-axis are supported by the support member 235, and the second cleaning roller 231 rotates about a rotation axis along the X-axis. The second cleaning roller 231 is rotationally driven by one of the gears of the gear group 210.

The brush unit 233 comes into contact with the second cleaning roller 231 to clean the second cleaning roller 231. The brush unit 233 is a substantially columnar member, is disposed such that a height direction of the column is along the X-axis, and is disposed side by side with the second cleaning roller 231 below the second cleaning roller 231. Both ends of the brush unit 233 in the direction along the X-axis are supported by the support member 235, and the brush unit 233 rotates about a rotation axis along the X-axis. The brush unit 233 is also rotationally driven by one of the gears of the gear group 210.

The blade unit 241 comes into contact with the brush unit 233 to clean the brush unit 233. The blade unit 241 is a substantially rectangular plate-shaped member and extends along a side surface of the brush unit 233. The blade unit 241 is supported by the support member 235.

The gear group 210 includes a plurality of gears. The plurality of gears are rotated by the driving by the cleaning roller drive motor 542 to rotate the shaft unit 221, the second cleaning roller 231, and the brush unit 233. The gear group 210 and the cleaning roller drive motor 542 are installed at an end portion of the frame unit 215 in the −X direction.

The support member 235 includes a main body (not illustrated) along the XZ plane and support units 235a and 235b protruding upward from both ends of the main body in the direction along the X-axis in plan view from above. The support units 235a and 235b face each other in the direction along the X-axis. The second contact mechanism 220, the second cleaning roller 231, the brush unit 233, and the blade unit 241 are arranged between the support units 235a and 235b. That is, the support units 235a and 235b support the second contact mechanism 220, the second cleaning roller 231, the brush unit 233, and the blade unit 241.

The support member 235 can relatively change a posture thereof with respect to the frame unit 215 while being supported by the frame unit 215. The posture change of the support member 235 will be described later.

The frame unit 215 is a substantially frame-shaped member in plan view from above, and the support member 235 is disposed inside the frame unit 215. At the end portion of the frame unit 215 in the −X direction, the gear group 210 is disposed in the −X direction positioned outside the end portion, and the cleaning roller drive motor 542 is disposed in the +X direction positioned inside the end portion. The cleaning roller drive motor 542 includes a shaft (not illustrated) serving as an output shaft. The shaft passes through the frame unit 215 and extends in the −X direction, and is directly coupled to one of the plurality of gears of the gear group 210. The frame unit 215 is supported by the frame of the third unit group 103 of the sheet manufacturing apparatus 1.

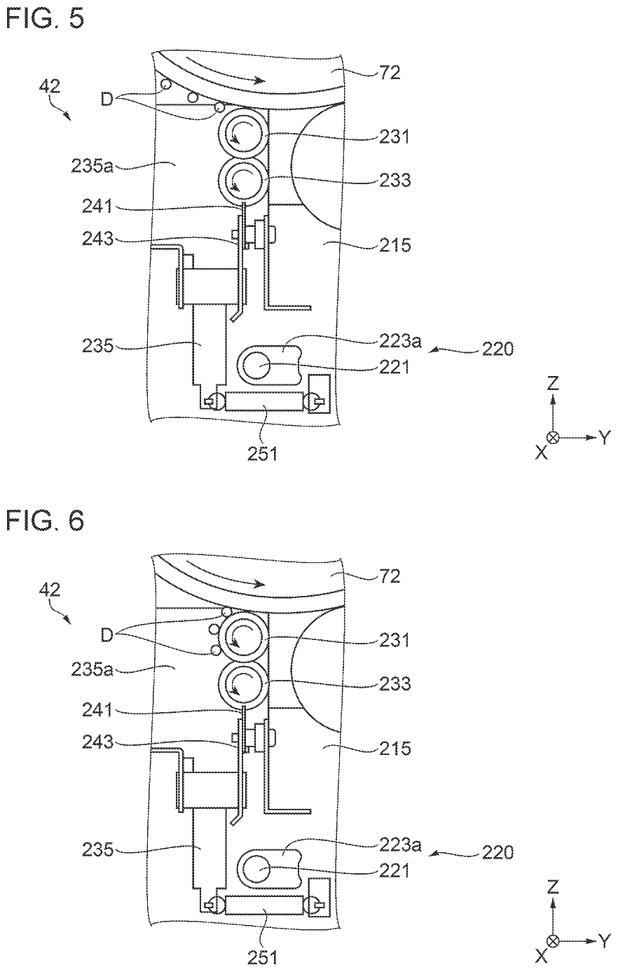

A function of the cleaning device 40 will be described with reference to FIG. 5 to FIG. 8. The first cleaning device 41 and the second cleaning device 42 are different in arrangement from each other, but have similar cleaning functions. For this reason, the second cleaning device 42 will be described as a representative example of the cleaning device 40. Note that FIG. 5 to GIG. 8 illustrate a state in which the second forming roller 72 and the second cleaning roller 231 are in contact with each other. Moreover, in description of FIG. 5 to FIG. 8, unless otherwise specified, a state in side view from the −X direction will be described.

As illustrated in FIG. 5, paper dust D from the web W (not illustrated) may adhere to the side surface of the second forming roller 72 due to the operation of the sheet manufacturing apparatus 1.

In the second cleaning roller 231, a surface portion corresponding to a side surface of the column comes into contact with the side surface of the second forming roller 72. While the second cleaning roller 231 is in contact with the second forming roller 72, the second forming roller 72, the second cleaning roller 231, and the brush unit 233 rotate. At this time, the second forming roller 72 rotates counterclockwise, and the second cleaning roller 231 and the brush unit 233 also rotate counterclockwise.

A spring member 251 is disposed along the Y-axis below the support member 235. An end portion of the spring member 251 in the −Y direction is fixed to a lower end portion of the support member 235, and an end portion of the spring member 251 in the +Y direction is fixed to the frame unit 215. Accordingly, the lower end portion of the support member 235 is biased in the +Y direction by the spring member 251.

The brush unit 233 is installed with a plurality of bristle materials substantially radially from the center of rotation. A side surface of the second cleaning roller 231 and the side surface of the brush unit 233 are arranged so as to overlap each other. This causes the side surface of the second cleaning roller 231 and the bristle materials of the brush unit 233 to come into relatively strong contact with each other. Thus, the bristle materials of the brush unit 233 come into contact with the side surface of the second cleaning roller 231 so as to rub the side surface of the second cleaning roller 231.

The blade unit 241 is disposed below the brush unit 233. The blade unit 241 is supported by the support member 235 with a fixing member 243 interposed therebetween, and is disposed such that an upper end portion thereof is embedded in the plurality of bristle materials on the side surface of the brush unit 233. The blade unit 241 is embedded in the brush unit 233 by a distance of, for example, about 1 mm.

Next, as illustrated in FIG. 6, the paper dust D adhering to the side surface of the second forming roller 72 reaches a region where the second forming roller 72 and the second cleaning roller 231 come into contact with each other due to the rotation of the second forming roller 72. Then, the second cleaning roller 231 comes into contact with the second forming roller 72 while rotating, thereby cleaning the side surface of the second forming roller 72. That is, the paper dust D adhering to the side surface of the second forming roller 72 is entangled by the side surface of the second cleaning roller 231 and moves to the second cleaning roller 231.

The side surface that is a surface portion of the second cleaning roller 231 is made of a felt material. Thus, the paper dust D and the like are easily entangled by the second cleaning roller 231. In addition, the side surface of the second cleaning roller 231 easily follows the shape of the side surface of the second forming roller 72. Thus, cleaning performance of the second cleaning roller 231 is improved.

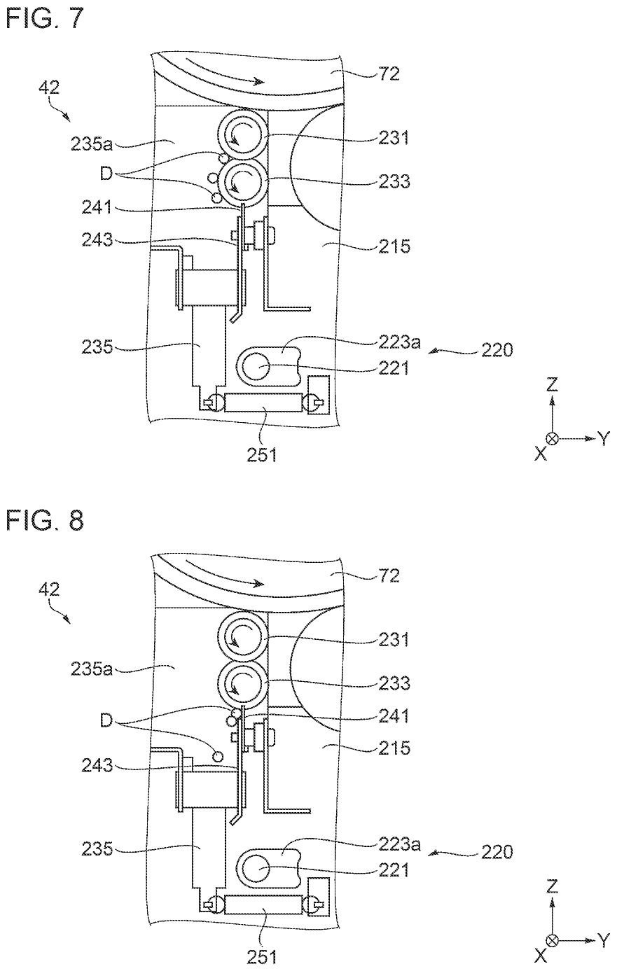

Next, as illustrated in FIG. 7, the paper dust D having moved to the side surface of the second cleaning roller 231 is entangled with the bristle materials of the brush unit 233 and moves to the brush unit 233. As a result, the side surface of the second cleaning roller 231 is cleaned, and the cleaning performance of the second cleaning roller 231 can be maintained.

Then, as illustrated in FIG. 8, the paper dust D having moved to the side surface of the brush unit 233 is scraped off by the blade unit 241 due to the rotation of the brush unit 233. Thus, the brush unit 233 is cleaned, and cleaning performance of the brush unit 233 for the second cleaning roller 231 can be maintained.

In this way, the paper dust D and the like adhering to the side surface of the second forming roller 72 are cleaned. Since the second cleaning device 42 corresponding to the second forming roller 72 is provided, the side surface of the second forming roller 72 is kept clean.

Note that as described above, since the function of the first cleaning device 41 is similar to that of the second cleaning device 42, description of the function of the first cleaning device 41 will be omitted. Since the first cleaning device 41 corresponding to the first forming roller 71 is provided in a manner similar to the second cleaning device 42, the side surface of the first forming roller 71 is kept clean.

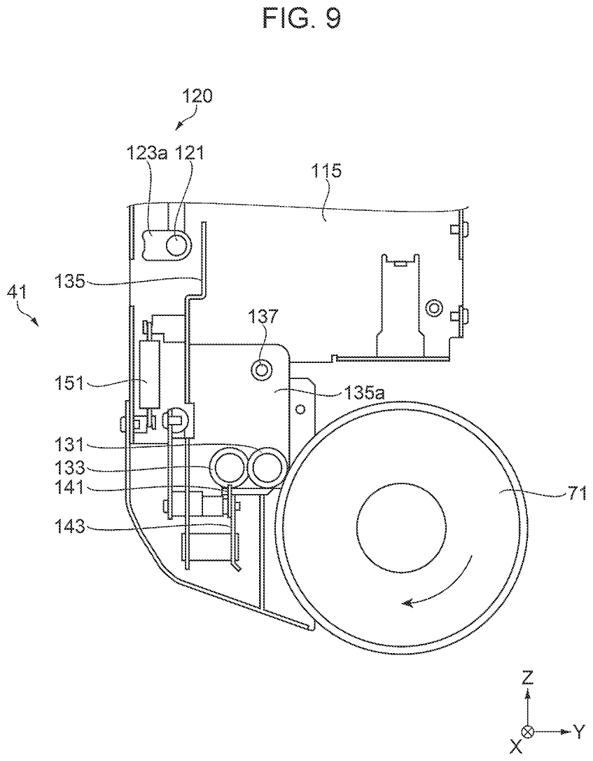

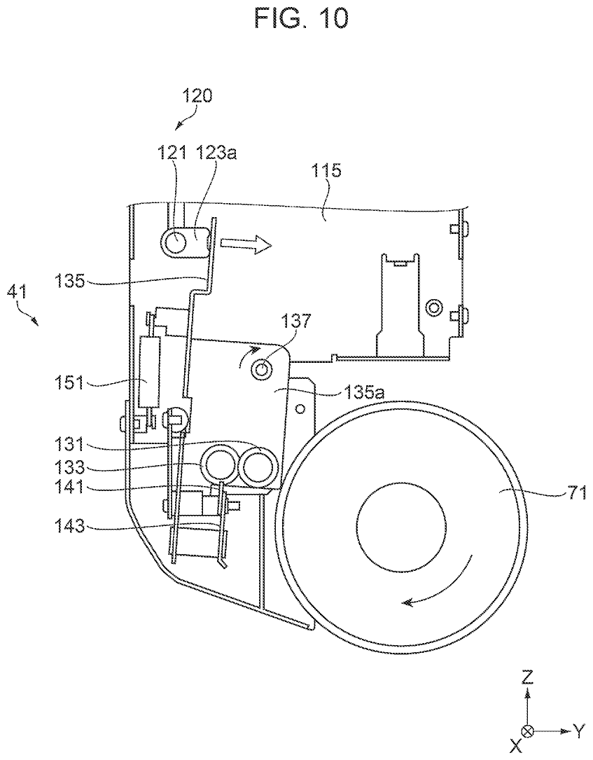

A configuration and a function of the first contact mechanism 120 in the first cleaning device 41 will be described with reference to FIG. 9 and FIG. 10. In FIG. 9 and FIG. 10, unless otherwise specified, a state in side view from the −X direction will be described.

As illustrated in FIG. 9, the first cleaning roller 131 is disposed in contact with the first forming roller 71 slightly above the first forming roller 71 in the −Y direction. FIG. 9 illustrates a state in which the first cleaning roller 131 is in contact with the first forming roller 71 to clean the side surface of the first forming roller 71.

The brush unit 133 is installed with a plurality of bristle materials substantially radially from the center of rotation. A side surface of the first cleaning roller 131 and the side surface of the brush unit 133 are arranged so as to overlap each other.

The first forming roller 71 rotates clockwise. The first cleaning roller 131 and the brush unit 133 also rotate clockwise.

The first contact mechanism 120 is disposed in the −Y direction with respect to an upper end portion of the support member 135, and faces the direction along the Y-axis. The cam member 123a and the cam member 123b (not illustrated) switch contact and separation of the first forming roller 71 with and from the first forming roller 71 due to rotation.

The cam members 123a and 123b have asymmetric shapes with respect to the shaft unit 121 serving as the center of rotation, and each of the cam members 123a and 123b includes a protruding portion (not illustrated). When the first cleaning roller 131 is brought into contact with the first forming roller 71, the protruding portion is positioned in a direction substantially opposite to the upper end portion of the support member 135.

The support member 135 is supported by the frame unit 115 so as to be rotatable about a rotation shaft 137. A spring member 151 is disposed along the Z-axis in the −Y direction with respect to the support member 135. An upper end portion of the spring member 151 is fixed to the support member 135, and a lower end portion of the spring member 151 is fixed to the frame unit 115.

The support member 135 is biased by the spring member 151 in a counterclockwise direction about the rotation shaft 137. Thus, the first cleaning roller 131 is brought into contact with the first forming roller 71 due to a biasing force of the spring member 151.

As illustrated in FIG. 10, when the first cleaning roller 131 separates from the first forming roller 71, the support member 135 changes the posture thereof. In detail, the shaft unit 121 rotates, and the protruding portion of the cam member 123a comes into contact with the upper end of the support member 135 from the −Y direction. At this time, a force by which the upper end of the support member 135 is biased substantially in the +Y direction due to the contact of the protruding portion of the cam member 123a is larger than the biasing force of the spring member 151. Thus, the support member 135 rotates clockwise about the rotation shaft 137 by a predetermined distance to change the posture thereof. As a result, the first cleaning roller 131 separates from the first forming roller 71.

Note that the above-described configuration and operation have been mainly described for an end portion of the support member 135 in the +X direction. At an end portion of the support member 135 in the −X direction, a configuration that includes the cam member 123b and that is similar to the above-described configuration is disposed. The configuration including the cam member 123b operates in a manner similar to the configuration described above in conjunction with the configuration described above. For this reason, description of the operation of the configuration including the cam member 123b is omitted.

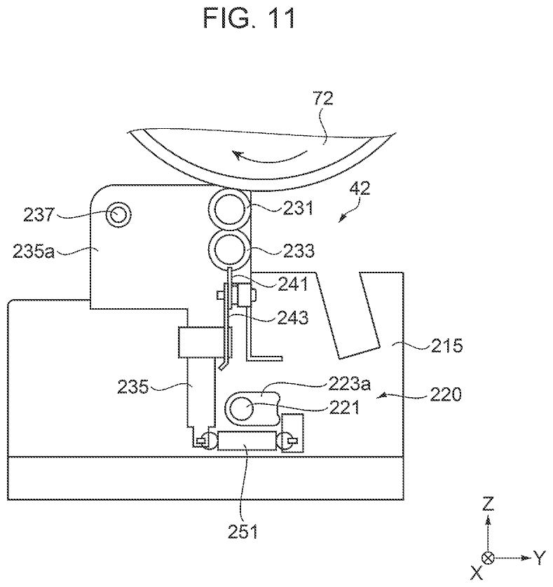

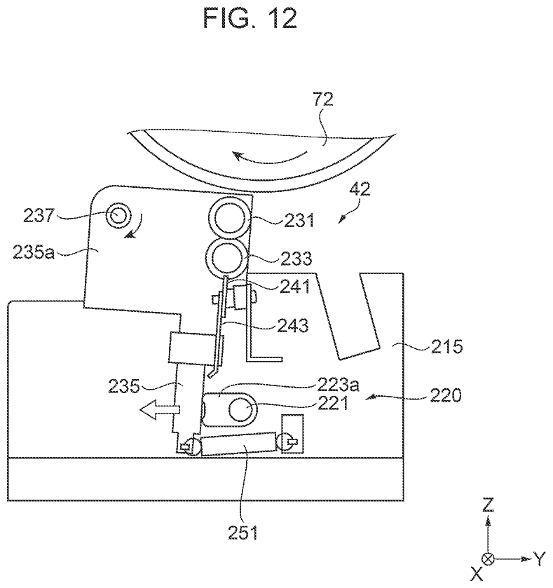

A configuration and a function of the second contact mechanism 220 in the second cleaning device 42 will be described with reference to FIG. 11 and FIG. 12. In FIG. 11 and FIG. 12, unless otherwise specified, a state in side view from the −X direction will be described.

As illustrated in FIG. 11, the second cleaning roller 231 is disposed in contact with the second forming roller 72 at a position that is below the second forming roller 72 and that is slightly in the −Y direction. FIG. 11 illustrates a state in which the second cleaning roller 231 is in contact with the second forming roller 72 to clean the side surface of the second forming roller 72.

The second contact mechanism 220 is disposed in the +Y direction with respect to the lower end portion of the support member 235, and faces the direction along the Y-axis. The cam member 223a and the cam member 223b (not illustrated) switch contact and separation of the second forming roller 72 with and from the second forming roller 72 due to rotation.

The cam members 223a and 223b have asymmetric shapes with respect to the shaft unit 221 serving as the center of rotation, and each of the cam members 223a and 223b has a protruding portion (not illustrated). When the second cleaning roller 231 is brought into contact with the second forming roller 72, the protruding portion is positioned in a direction substantially opposite to the lower end portion of the support member 235.

The support member 235 is supported by the frame unit 215 so as to be rotatable about the rotation shaft 237. The spring member 251 is disposed along the Y-axis in the +Y direction of the support member 235. An end portion of the spring member 251 in the −Y direction is fixed to the lower end of the support member 235, and an end portion of the spring member 251 in the +Y direction is fixed to the frame unit 215.

The support member 235 is biased by the spring member 251 in a counterclockwise direction about the rotation shaft 237. For this reason, the second cleaning roller 231 comes into contact with the second forming roller 72 due to a biasing force of the spring member 251.

As illustrated in FIG. 12, when the second cleaning roller 231 separates from the second forming roller 72, the support member 235 changes the posture thereof. In detail, the shaft unit 221 rotates, and the protruding portion of the cam member 223a comes into contact with the lower end of the support member 235 from the +Y direction. At this time, a force by which the lower end of the support member 235 is biased substantially in the −Y direction due to the contact of the cam member 223a is larger than the biasing force of the spring member 251. For this reason, the support member 235 rotates clockwise about the rotation shaft 237 by a predetermined distance. Thus, the second cleaning roller 231 separates from the second forming roller 72.

Note that the above-described configuration and operation have been mainly described for an end portion of the support member 235 in the +X direction. At an end portion of the support member 235 in the −X direction, a configuration that includes the cam member 223b and that is similar to the above-described configuration is disposed. The configuration including the cam member 223b operates in a manner similar to the configuration described above in conjunction with the configuration described above. For this reason, the operation of the configuration including the cam member 223b is omitted.

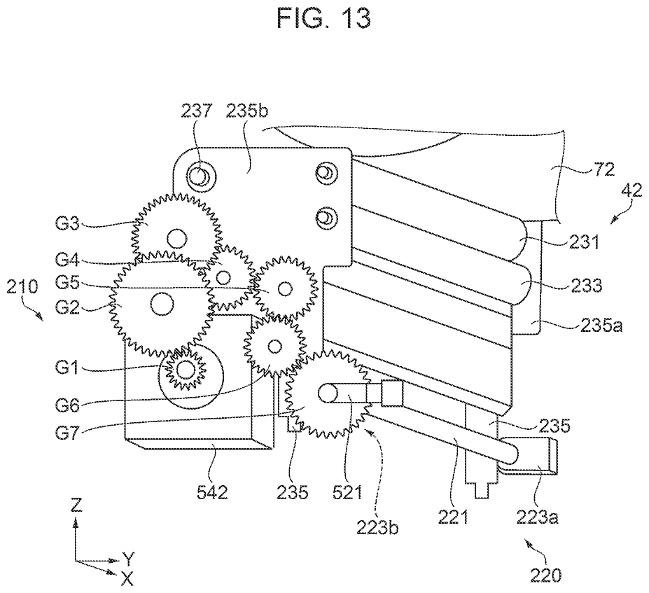

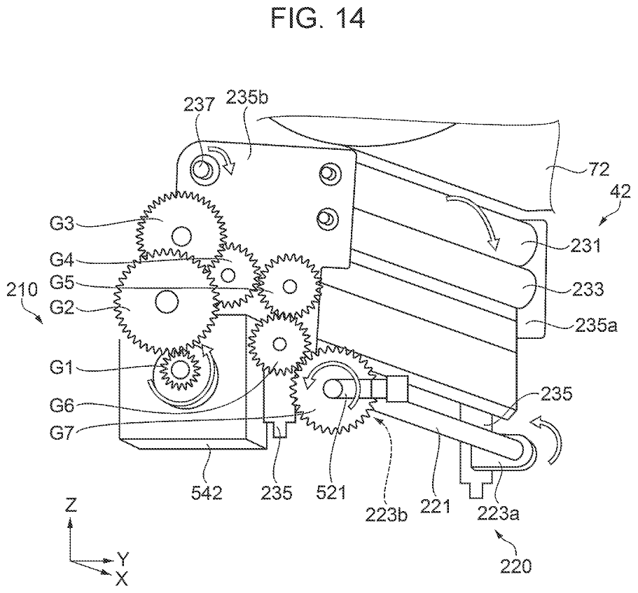

An operation mechanism of the second contact mechanism 220 will be described with reference to FIG. 13 and FIG. 14. FIG. 13 illustrates a state in which the second cleaning roller 231 is in contact with the second forming roller 72, and FIG. 14 illustrates a state in which the second cleaning roller 231 separates from the second forming roller 72. Note that since the operation mechanism of the first contact mechanism 120 is similar to that of the second contact mechanism 220, description of the operation mechanism of the first contact mechanism 120 is omitted.

As illustrated in FIG. 13, the gear group 210 includes gears G1, G2, G3, G4, G5, G6, and G7. The gear G1 to the gear G7 are arranged so as to be engaged with each other in the above-described order. The gear G1 is directly coupled to the output shaft of the cleaning roller drive motor 542. Each gear of the gear group 210 rotates about a rotation axis along the X-axis.

A rotational driving force of the cleaning roller drive motor 542 is transmitted from the gear G1 to the gear G2. The gear G2 includes a gear that is not illustrated and that is engaged with the gear G3 in the +X direction with respect to a gear that is engaged with the gear G1. Thus, the rotational driving force is sequentially transmitted from the gear G2 to the gear G3, and is further transmitted from the gear G3 to the gear G4, the gear G5, the gear G6, and the gear G7.

In the second contact mechanism 220, the end portion of the shaft unit 221 in the −X direction is fixed to the gear G7. Thus, the rotational driving force transmitted to the gear G7 rotates the shaft unit 221 and the cam members 223a and 223b. That is, the second contact mechanism 220 is driven by the cleaning roller drive motor 542.

A cam position detection sensor 521 is disposed at an outer periphery of the gear G7. The cam position detection sensor 521 optically senses rotation of the gear G7 to detect rotation positions of the cam members 223a and 223b.

Note that the second cleaning roller 231 and the brush unit 233 are rotationally driven by the cleaning roller drive motor 542 through gears (not illustrated) of the gear group 210 from the gear G3.

As illustrated in FIG. 14, when the cleaning roller drive motor 542 is driven, the support member 235 changes the posture thereof. In detail, the cleaning roller drive motor 542 is rotated counterclockwise in side view from the −X direction. The rotational driving force is sequentially transmitted to rotate the gear G6 clockwise and to rotate the gear G7 counterclockwise, in side view from the −X direction.

The rotational driving force transmitted to the gear G7 causes the shaft unit 221 and the cam members 223a and 223b to rotate counterclockwise in side view from the −X direction. As described above, each of the protruding portion of the cam member 223a and the protruding portion of the cam member 223b presses and biases the support member 235 substantially in the −Y direction. Thus, the support member 235 rotates clockwise by a certain distance about the rotation shaft 237 in side view from the −X direction. As a result, the second cleaning roller 231 moves substantially in the +Y direction and downward with respect to the second forming roller 72 and separates from the second forming roller 72. Note that in side view from the −X direction, each of rotation directions of the shaft unit 221 and the cam members 223a and 223b is one direction of the counterclockwise direction.

When the cleaning roller drive motor 542 further rotates counterclockwise from the state in which the second cleaning roller 231 separates from the second forming roller 72, the protruding portions of the cam members 223a and 223b separate from the support member 235. Accordingly, the support member 235 rotates counterclockwise in side view from the −X direction due to the biasing of the spring member 251 described above. Then, the second cleaning roller 231 comes into contact with the second forming roller 72 and returns to the state illustrated in FIG. 13.

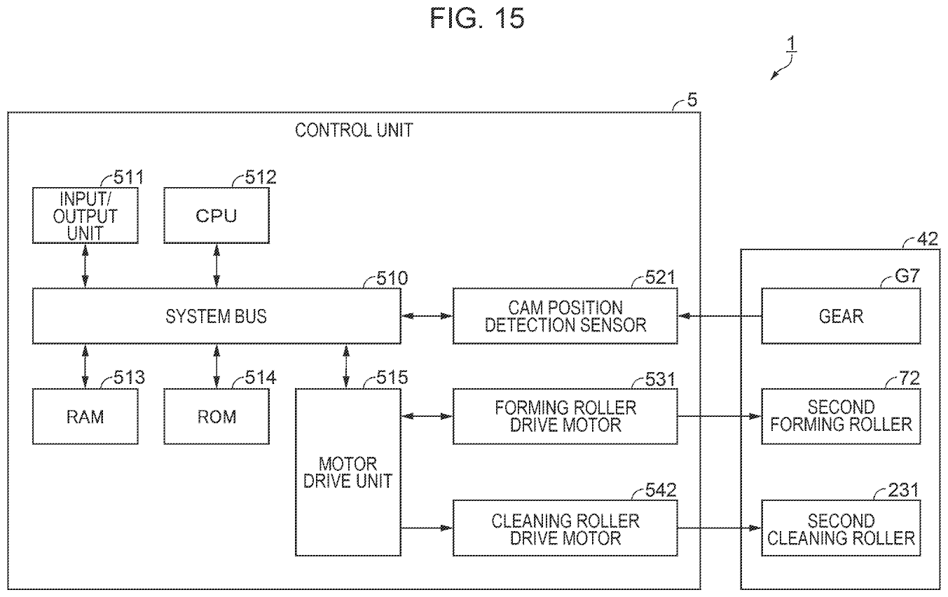

A function of the control unit 5 will be described with reference to FIG. 15 by using the second cleaning device 42 as a representative example of the first cleaning device 41 and the second cleaning device 42. Note that in FIG. 15, the first cleaning device 41 and related constitutions are not illustrated. The control unit 5 controls the first cleaning device 41 in a manner similar to the second cleaning device 42. Thus, detailed description related to control of the first cleaning device 41 is omitted.

As illustrated in FIG. 15, the sheet manufacturing apparatus 1 includes the control unit 5 and the second cleaning device 42. The control unit 5 includes a system bus 510, an input/output unit 511, a central processing unit (CPU) 512, a random access memory (RAM) 513, a read only memory (ROM) 514, a motor drive unit 515, the cam position detection sensor 521, a forming roller drive motor 531, and the cleaning roller drive motor 542. The forming roller drive motor 531 is an example of a motor that drives the forming roller of the present disclosure.

The control unit 5 integrally controls the operations of the configurations of the sheet manufacturing apparatus 1 including the first contact mechanism 120 and the second contact mechanism 220 described above. The control unit 5 controls the first contact mechanism 120 and the second contact mechanism 220, which can cause the first cleaning roller 131 to separate from the first forming roller 71 and cause the second cleaning roller 231 to appropriately separate from the second forming roller 72.

The CPU 512 performs overall control of the sheet manufacturing apparatus 1. The CPU 512 is electrically coupled to the input/output unit 511, the RAM 513, the ROM 514, the motor drive unit 515, and the cam position detection sensor 521 through the system bus 510.

The RAM 513 temporarily stores data. Various control programs executed by the CPU 512, a maintenance sequence, and the like are stored in the ROM 514. The input/output unit 511 receives an operation instruction from an external information terminal such as a personal computer, and transmits various kinds of information of the sheet manufacturing apparatus 1 to the information terminal.

The motor drive unit 515 is electrically coupled to the forming roller drive motor 531 corresponding to the second forming roller 72 and the cleaning roller drive motor 542. The forming roller drive motor 531 drives the rotation of the second forming roller 72. As a result, the second forming roller 72 rotates, and the web W described above is heated and pressurized.

The forming roller drive motor 531 is a stepping motor, and an operation amount is controlled by the number of steps. The number of steps is defined by a frequency at the time of driving. The control unit 5 can detect a rotation angle of the second forming roller 72 from the number of steps for operating the second forming roller 72. Thus, from the rotation positions of the cam members 223a and 223b detected by the cam position detection sensor 521 and the rotation angle described above, the control unit 5 can separate the second cleaning roller 231 from the second forming roller 72 at a freely selected rotation angle of the second forming roller 72. That is, the second cleaning roller 231 can be separated from or brought into contact with the second forming roller 72 at a desired timing. The cleaning roller drive motor 542 drives the second cleaning roller 231. The control unit 5 controls a rotation direction and a rotation speed of the second cleaning roller 231 by using the cleaning roller drive motor 542. Thus, the rotation direction and the rotation speed of the second cleaning roller 231 are variable, and cleaning conditions of the second cleaning roller 231 are changed. This can improve cleaning performance of the second cleaning roller 231.

The control unit 5 may cause the second cleaning roller 231 to come into contact with the second forming roller 72 in at least one rotation or more of several rotations of the second forming roller 72. That is, the second cleaning roller 231 comes into contact with the second forming roller 72 during at least one rotation of the second forming roller 72. Thus, the entire circumference of the side surface of the second forming roller 72 is cleaned by the second cleaning roller 231, which can improve durability of the second cleaning roller 231 while ensuring cleanliness of the second forming roller 72.

Although not illustrated, the control unit 5 includes the cam position detection sensor corresponding to the first contact mechanism 120, the forming roller drive motor 531 corresponding to the first forming roller 71, and the cleaning roller drive motor 541.

The motor drive unit 515 is electrically coupled to the forming roller drive motor 531 serving as a motor corresponding to the first forming roller 71, and the cleaning roller drive motor 541 serving as a motor corresponding to the first cleaning roller 131. The forming roller drive motor 531 drives the rotation of the first forming roller 71, and the operation amount is controlled by the number of steps defined by the frequency at the time of driving. That is, the control unit 5 can detect the rotation angle of the first forming roller 71 from the number of steps for operating the first forming roller 71. As a result, from the above-described rotation positions of the cam members 123a and 123b detected by the cam position detection sensor and the above-described rotation angle, the control unit 5 can separate the first cleaning roller 131 from the first forming roller 71 at a freely selected rotation angle of the first forming roller 71.

The cleaning roller drive motor 541 corresponding to the first cleaning roller 131 drives the first cleaning roller 131. The control unit 5 controls a rotation direction and a rotation speed of the first cleaning roller 131 by using the cleaning roller drive motor 541.

The control unit 5 may cause the first cleaning roller 131 to come into contact with the first forming roller 71 in at least one rotation or more of several rotations of the first forming roller 71. That is, the first cleaning roller 131 comes into contact with the first forming roller 71 during at least one rotation of the first forming roller 71. Thus, the entire circumference of the side surface of the first forming roller 71 is cleaned by the first cleaning roller 131, which can improve durability of the first cleaning roller 131 while ensuring cleanliness of the first forming roller 71.

Also in the first cleaning device 41, an effect similar to that of the second cleaning device 42 can be obtained due to the control by the control unit 5.

According to the present embodiment, the following effects can be obtained.

The durability of the first cleaning roller 131 and the second cleaning roller 231 can be improved. In detail, it is possible to separate the first cleaning roller 131 from the first forming roller 71 and to appropriately separate the second cleaning roller 231 from the second forming roller 72. Thus, wear and deformation of the side surfaces that are the surface portions of the first cleaning roller 131 and the second cleaning roller 231 are suppressed. As a result, the sheet manufacturing apparatus 1, the first cleaning device 41, and the second cleaning device 42 that improve the durability of the first cleaning roller 131 and the second cleaning roller 231 can be provided.

In addition, although the first forming roller 71 and the second forming roller 72 have higher durability than those of the first cleaning roller 131 and the second cleaning roller 231, since the first forming roller 71 and the second forming roller 72 are always in contact with these cleaning rollers, there is a possibility that wear or the like of the surfaces progress. On the other hand, appropriately separating the first cleaning roller 131 and the second cleaning roller 231 can also improve the durability of the first forming roller 71 and the second forming roller 72.

What is claimed is:

1. A sheet manufacturing apparatus comprising:
a forming roller configured to heat and pressurize a web including a fiber;
a cleaning roller configured to come into contact with the forming roller, the cleaning roller being configured to clean the forming roller; and
a contact mechanism configured to switch contact and separation of the cleaning roller with and from the forming roller.

2. The sheet manufacturing apparatus according to claim 1, further comprising:
a control unit configured to control the contact mechanism.

3. The sheet manufacturing apparatus according to claim 2, wherein
the control unit
includes a cleaning roller drive motor configured to drive the cleaning roller, and
controls a rotation direction and a rotation speed of the cleaning roller by using the cleaning roller drive motor.

4. The sheet manufacturing apparatus according to claim 3, wherein
the contact mechanism includes a cam member configured to switch the contact and the separation of the cleaning roller by rotation, and
the control unit
includes
a motor configured to drive the forming roller and
a cam position detection sensor configured to detect a rotation position of the cam member,
detects a rotation angle of the forming roller from an operation amount of the motor, and
causes the cleaning roller to separate from the forming roller at the rotation angle freely selected, of the forming roller.

5. The sheet manufacturing apparatus according to claim 4, wherein
the control unit causes the cleaning roller to come into contact with the forming roller in at least one rotation or more of several rotations of the forming roller.

6. The sheet manufacturing apparatus according to claim 1, further comprising:
a brush unit configured to come into contact with the cleaning roller, the brush unit being configured to clean the cleaning roller.

7. The sheet manufacturing apparatus according to claim 6, further comprising:
a blade unit configured to come into contact with the brush unit, the blade unit being configured to clean the brush unit.

8. The sheet manufacturing apparatus according to claim 1, wherein
a surface portion of the cleaning roller configured to come into contact with the forming roller is made of a felt material.

9. The sheet manufacturing apparatus according to claim 1, wherein
the forming roller includes a first forming roller and a second forming roller,
the web is heated and pressurized while being pinched between the first forming roller and the second forming roller,
the cleaning roller includes a first cleaning roller configured to clean the first forming roller and a second cleaning roller configured to clean the second forming roller, and
the contact mechanism includes a first contact mechanism corresponding to the first cleaning roller and a second contact mechanism corresponding to the second cleaning roller.

10. A cleaning device comprising:
a cleaning roller configured to clean a forming member to which paper dust adheres;
a contact mechanism configured to switch contact and separation of the cleaning roller with and from the forming member; and
a control unit configured to control the contact mechanism.
